(19) United States
(12) Patent Application Publication
(10) Pub. No.: US 2016/0129286 A1
(43) Pub. Date: May 12, 2016

(54) Breathing Mask With Variable Airflow Resistance Insert

(71) Applicant: Training Mask, LLC, Cadillac, MI (US)

(72) Inventor: Casey Danford, Cadillac, MI (US)

(21) Appl. No.: 14/535,641

(22) Filed: Nov. 7, 2014

(51) Int. Cl. A62B 18/10; A62B 18/02

(52) U.S. Cl. CPC A62B 18/10; A62B 18/02

(57) ABSTRACT

A breathing mask having a face mask with a breathing port and a variable breathing resistance insert attached to the port. The insert includes an air resistance valve including a cap having a first plurality of apertures arranged in an arcuate arrangement, and a base attached rotatably to the cap and having a second plurality of apertures arranged in an arcuate arrangement. The cap is incrementally rotatable relative to the base between a first position, in which each of the first plurality of apertures of the cap is aligned with a corresponding one of the second plurality of apertures of the base, and a second position, in which one of the first plurality of apertures of the cap is aligned with one of the second plurality of apertures of the base, and the remainder of the first plurality of apertures of the cap is not aligned with any of the remainder of the second plurality of apertures of the base. The insert includes a connecting ring attached to the base and is adapted to be secured to the breathing port of the face mask.

### FIELD OF THE INVENTION

The present invention relates to a breathing mask and, more particularly, to a breathing mask having a variable airflow resistance insert for variably restricting airflow to and from the breathing mask.

### BACKGROUND OF THE INVENTION

Breathing masks, gas masks and respirators are worn by individuals who work in hazardous environments, such as firefighters, rescue workers, coal miners, and the like. These masks prevent individuals from inhaling smoke, gases, or other dangerous substances present in the air of the environment. Thus, the individuals, especially firefighters and rescue workers, must constantly train with their masks and equipment to simulate certain field-like situations. What is needed is a breathing mask that varies air inhalation resistance to assist in the user's training regimen and helping increase his/her stamina.

### SUMMARY OF THE INVENTION

In an embodiment, a breathing resistance insert for a breathing mask, comprising an air resistance valve including a cap having a first surface and a second surface opposite the first surface, and a first plurality of apertures each of which extends from the first surface to the second surface, the first plurality of apertures being spaced apart from one another and arranged in an arcuate arrangement, and a base attached rotatably to the cap, the base having a shank portion and a head located at one end of the shank portion, the head having a first surface and a second surface opposite the first surface of the head, and a second plurality of apertures each of which extends from the first surface of the head to the second surface of the head, the second plurality of apertures being spaced apart from one another and arranged in an arcuate arrangement, wherein the cap is rotatable relative to the base between a first position, in which each of the first plurality of apertures of the cap is aligned with a corresponding one of the second plurality of apertures of the base, and a second position, in which one of the first plurality of apertures of the cap is aligned with one of the second plurality of apertures of the base, and the remainder of the first plurality of apertures of the cap is not aligned with any of the remainder of the second plurality of apertures of the base; and a connecting ring attached to the shank portion of the base, the ring adapted to be secured to a breathing port of the breathing mask.

In an embodiment, the cap is rotatable relative to the cap to at least one intermediate position located between the first position and the second position, wherein when the cap is in the at least one intermediate position, at least two of the first plurality of apertures of the cap is aligned with a corresponding one of the second plurality of apertures of the base, and the remainder of the first plurality of apertures of the cap is not aligned with any of the remainder of the second plurality of apertures of the base. In an embodiment, the at least one intermediate position includes a plurality of intermediate positions.

In an embodiment, the diameters of each of the first plurality of apertures decreases sequentially from one end of the arcuate arrangement to an opposite end of the arcuate arrangement, and wherein the diameters of each of the second plurality of apertures decreases sequentially from one end of the arcuate arrangement of the second plurality of apertures to an opposite end of the arcuate arrangement of the second plurality of apertures. In an embodiment, the cap includes an inner cavity and an inner radial surface having at least one projection extending therefrom and into the inner cavity, and the base includes an outer radial surface and a plurality of notches formed within the outer radial surface and spaced apart from one another, the at least one projection being sized and shaped to engage each of the plurality of notches at one time and enabling the cap to be rotated relative to the base incrementally from the first position to the second position.

In an embodiment, the shank portion of the base includes external threads and the connecting ring includes an inner surface having internal threads that engage threadedly the external threads of the shank portion of the base. In an embodiment, the connecting ring includes an outer radial surface that is sized and shaped to be inserted within the breathing port of the breathing mask. In an embodiment, the connecting ring includes at least one clip adapted to mate with the breathing port of the breathing mask. In an embodiment, the cap includes gripping means for facilitating the rotation of the cap relative to the base. In an embodiment, the mask is a firefighter mask.

### BRIEF DESCRIPTION OF THE DRAWINGS

Reference is made to the following detailed description of the exemplary embodiment considered in conjunction with the accompanying drawings, in which:

FIG. 1 is a front perspective view of a breathing mask constructed in accordance with an exemplary embodiment of the present invention;

FIG. 2 is an exploded, side perspective view of the breathing mask shown in FIG. 1;

FIG. 3 is an exploded perspective view of a breathing resistance insert employed by the breathing mask shown in FIG. 2;

FIG. 4A is a bottom plan view of a variable resistance valve employed by the breathing resistance insert shown in FIG. 3 and being shown in a first, fully “open” position;

FIG. 4B is a bottom plan view of the valve shown in FIG. 4A, but being shown in a second, “closed” position;

FIG. 5 is a cross-sectional view of the breathing mask of FIG. 1 shown along section line 5-5 and looking in the direction of the arrows;

FIG. 6 is a side elevational view of a base of the valve shown in FIGS. 4A and 4B;

FIG. 7 is a side elevational view of a cap of the valve shown in FIGS. 4A and 4B;

FIG. 8 is a top plan view of the cap shown in FIG. 7;

FIG. 9 is a bottom plan view of the cap shown in FIG. 7;

FIG. 10 is a bottom plan view of the base shown in FIG. 6;

FIG. 11 is a top plan view of the base shown in FIG. 6; and

FIG. 12 is a front perspective view of a connecting ring of the valve shown in FIGS. 4A and 4B.

### DETAILED DESCRIPTION OF THE DRAWINGS

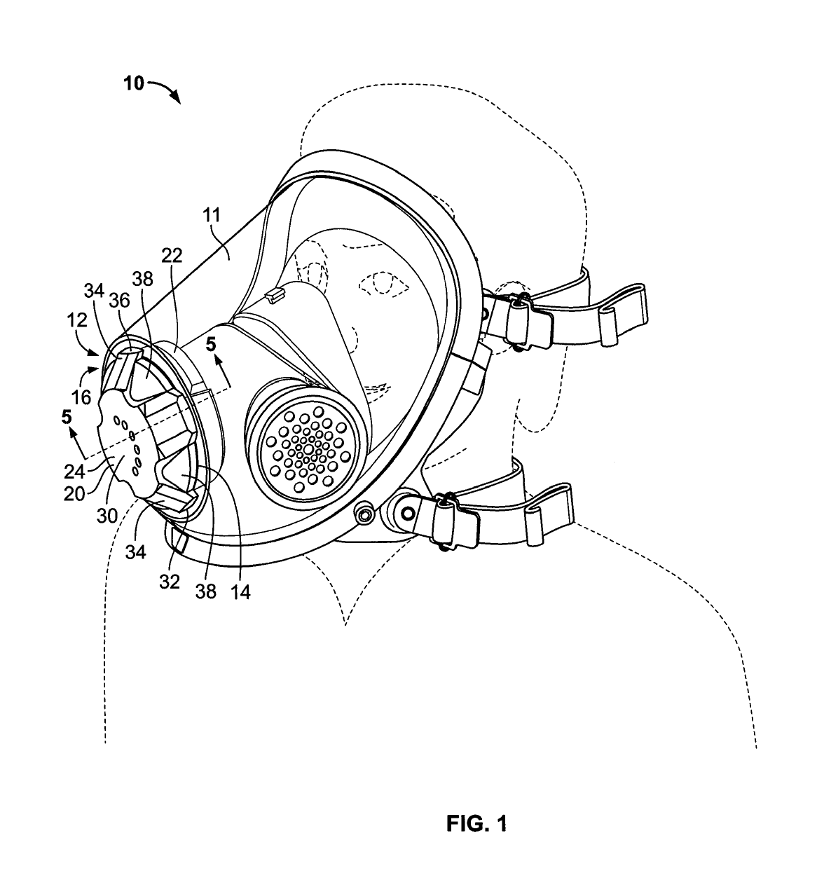

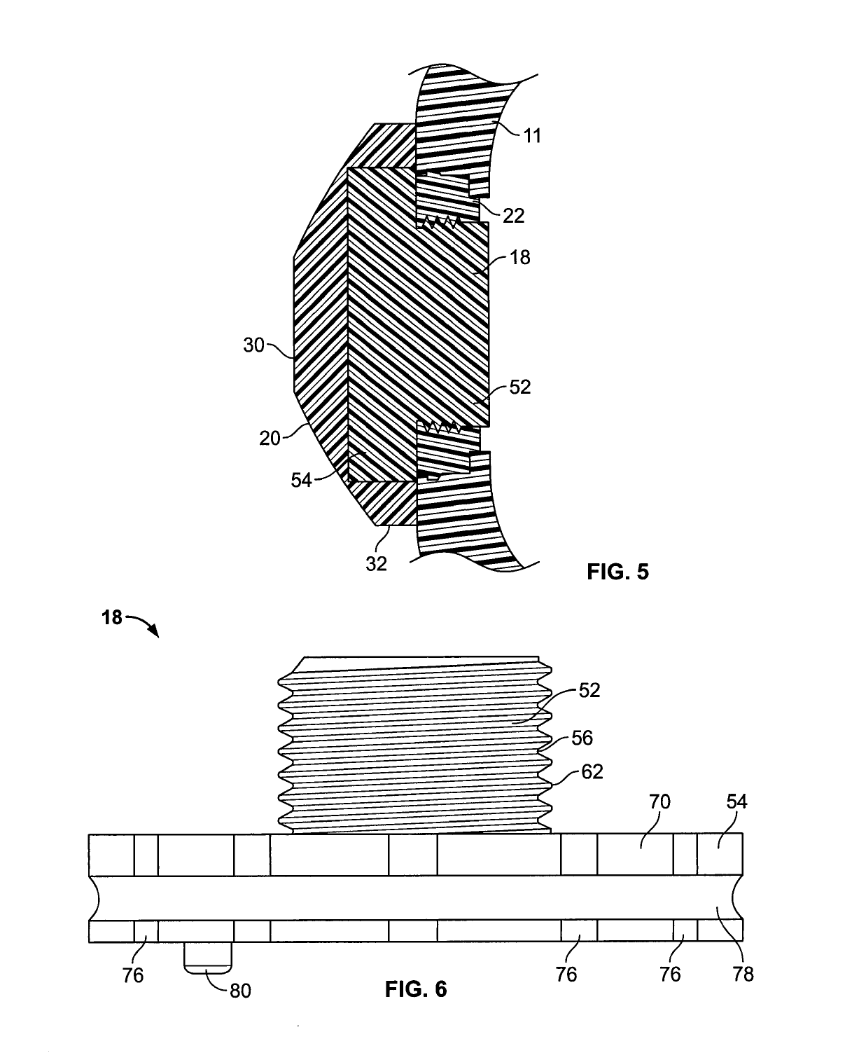

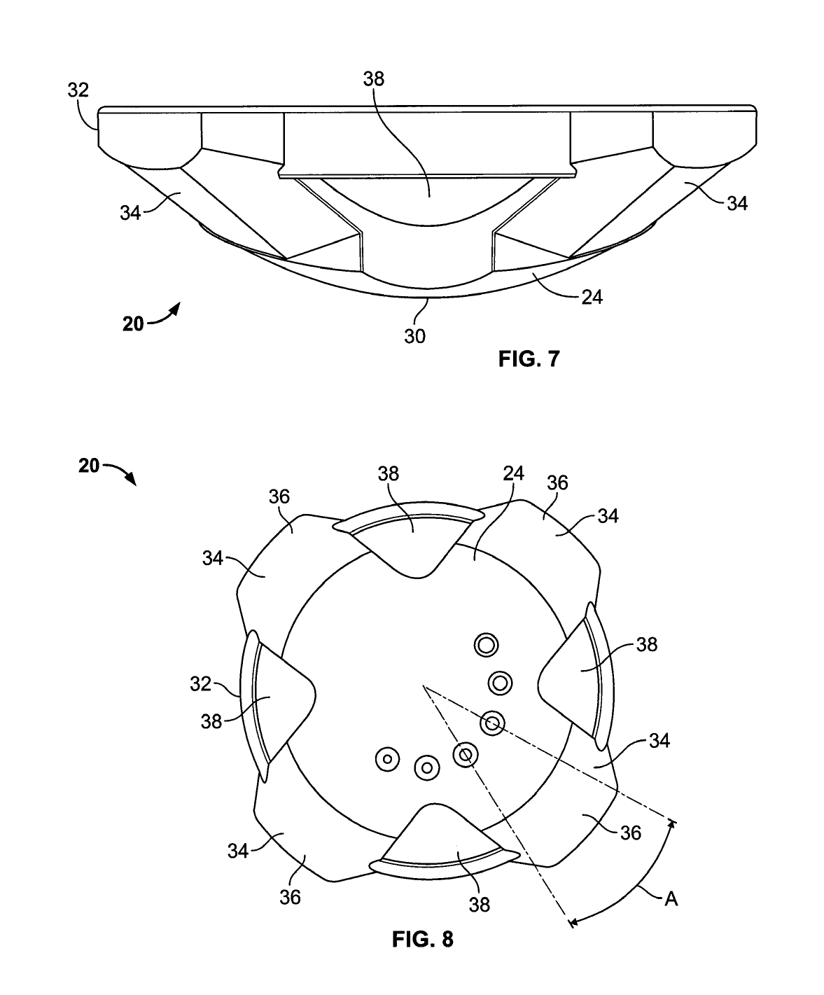

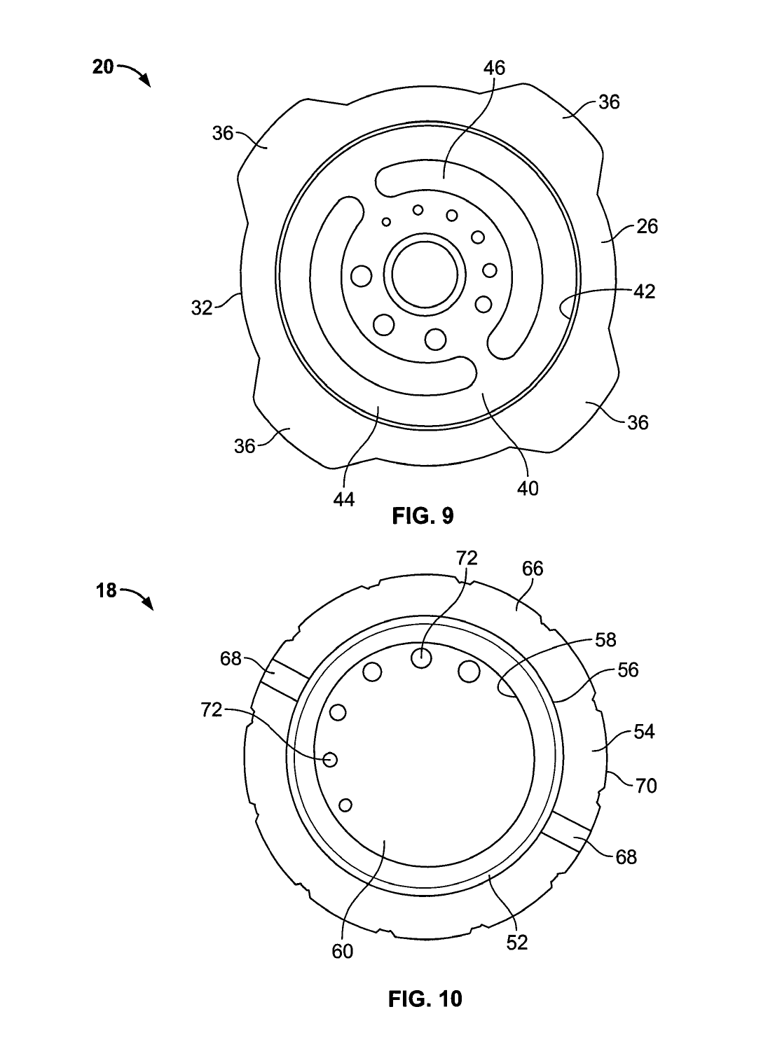

FIGS. 1-12 illustrate a breathing mask 10 constructed in accordance with an exemplary embodiment of the present invention. The breathing mask 10 includes a breathing resistance insert 12 attached removably to a breathing port 14 of a face mask 11. In an embodiment, the insert 12 is snapped into the port 14, which shall be described below. In another embodiment, the insert 12 is attached threadedly to the port 14 of the face mask 11 (not shown in the Figures). In an embodiment, the insert 12 includes a valve 16 having a base 18 and a cap 20 that receives rotatably the base 18, and a connecting ring 22 attached to the base 18 of the valve 16. In an embodiment, the face mask 11 is a firefighter mask. In other embodiments, the face mask 11 can be any type of breathing mask, gas mask or respirator known in the art.

Referring to FIGS. 1-3 and 7-9, in an embodiment, the cap 20 includes a raised, first surface 24, a second, inner surface 26 opposite the first surface 24, and a first plurality of apertures 28 extending from the first surface 24 to the second surface 26. In an embodiment, each of the first plurality of apertures 28 is spaced an equal circumferential distance A from the center points of each other (see FIG. 8). In an embodiment, the first plurality of apertures 28 is arranged in a semi-circular or arcuate orientation. In other embodiments, the first plurality of apertures 28 may be arranged in a circular orientation or any other suitable orientation. In the embodiment shown, the plurality of apertures 28 includes six (6) of the apertures 28. In other embodiments, any number of the apertures 28 may be used. In other embodiments, at the second surface 26 of the cap 20, the end of each of the plurality of apertures 28 has a different diameter than those of the remaining apertures 28. In an embodiment, the diameter of each aperture 28 decreases from one end of the arcuate arrangement of the apertures 28 to the other end of the arcuate arrangement of the apertures 28. As will be described in detail below, the plurality of apertures 28 permits the passage of inhaled air therethrough at a variable rate and resistance.

With continued reference to FIGS. 1-3 and 7-9, the first surface 24 of the cap 20 has a substantially dome-like shape including an apex 30 opposite a cap perimeter 32 located proximate the second surface 26. A plurality of arms 34 is located on the first surface 24, each of which extends from the apex 30 to the cap perimeter 32. As shown in FIGS. 1, 2 and 8, each of the plurality of arms 34 extends radially beyond the cap perimeter 32 and terminates in a plurality of tabs 36. Each of a plurality of grooves 38 is formed in between a corresponding pair of each of the plurality of arms 34 and is sized and shaped to accommodate a user's fingers. The arms 34, tabs 36, and grooves 38 provide gripping means to help promote the user's ability to grip the cap 20 and provide rotational force thereto so as to manipulate the rotational location of the cap 20 relative to the base 18, thereby controlling the amount of airflow through the valve 16, as will be discussed in detail below. It shall be understood that, in other embodiments, the cap 20 can employ other gripping means known in the art, such as frictional surfaces, knurling, etc.

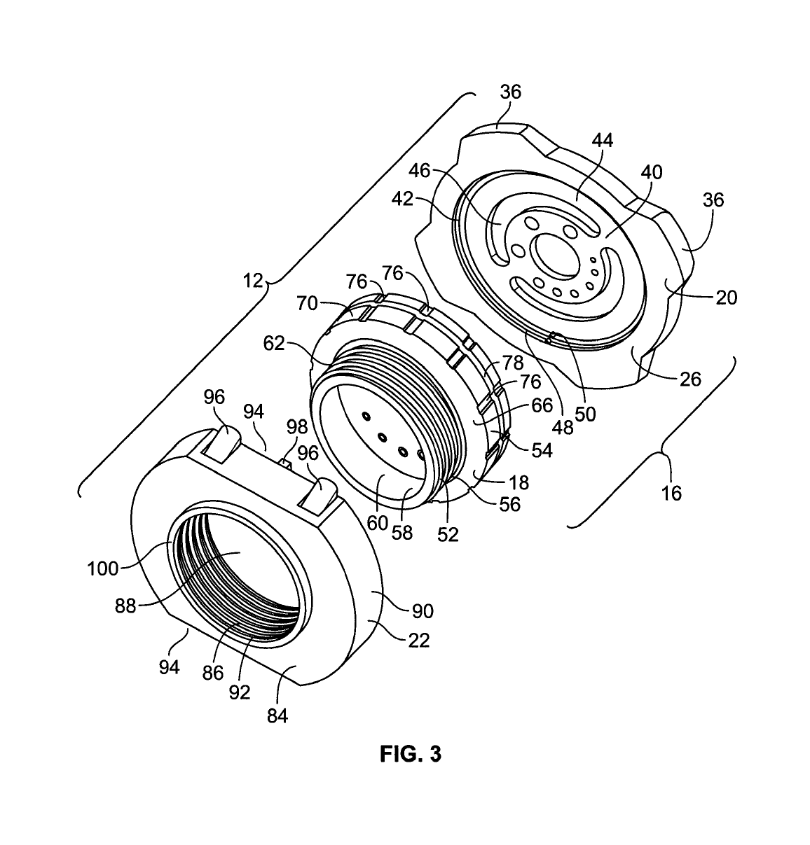

Referring now to FIGS. 3-4B and 9, in an embodiment, the cap 20 includes an inner cavity 40 having an inner radial surface 42 and a bottom surface 44 having at least one elongated semi-circular (i.e., arcuate) track or channel 46. The inner radial surface 42 includes a lip 48 extending circumferentially and intermediate the bottom surface 44 and the second surface 26. The inner radial surface 42 further includes at least one tab or projection 50 extending vertically from the bottom surface 44 to the second surface 26. While the embodiment as shown depicts two projections 50, any number of projections 50 can be used as described below.

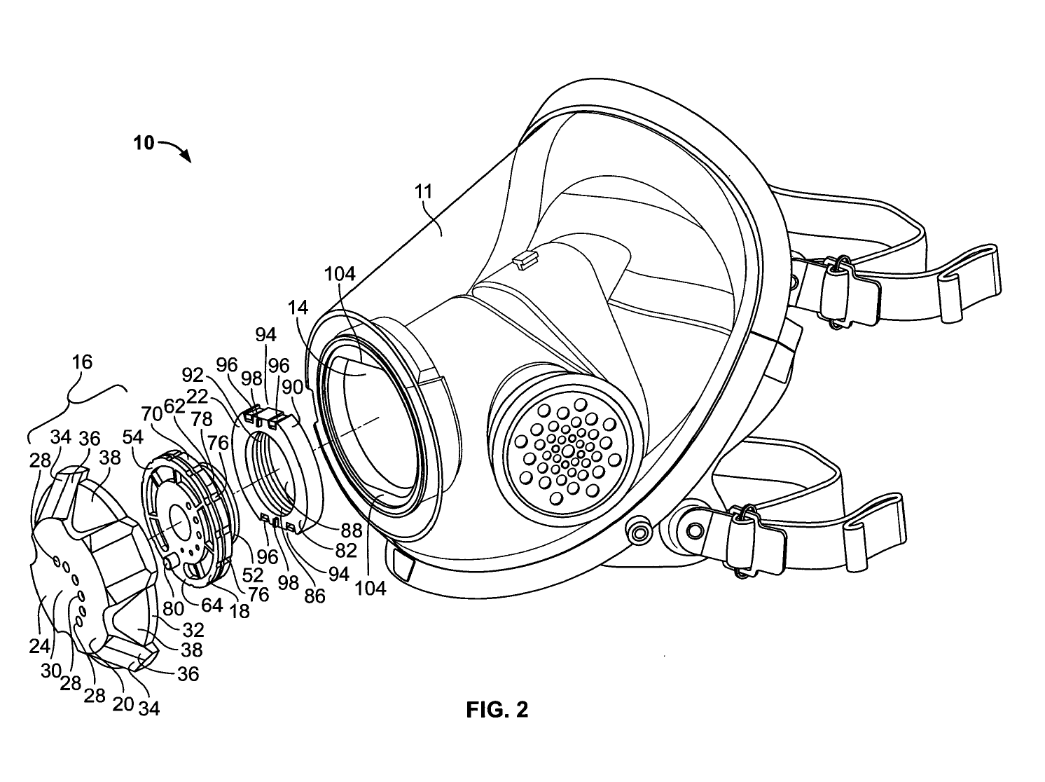

Referring now to FIGS. 2-4B, 6, 10 and 11, the base 18 includes a threaded cylindrical shank portion 52 and a disc-shaped portion or head 54 formed at one end of the shank portion 52. The shank portion 52 of the base 18 includes an outer surface 56 and an interior surface 58 defined by an interior aperture 60. In an embodiment, the outer surface 56 includes a plurality of external threads 62 adapted to engage with internal threads of the connecting ring 22. In other embodiments, the outer surface 56 may be formed with clips thereon (not shown) or other connecting mechanisms which allow for sufficient securement between the base 18 and the connecting ring 22.

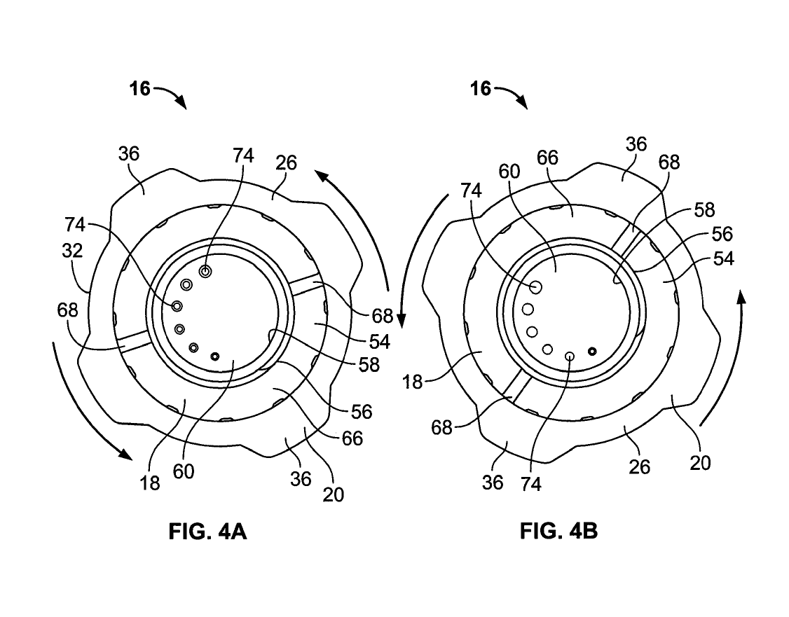

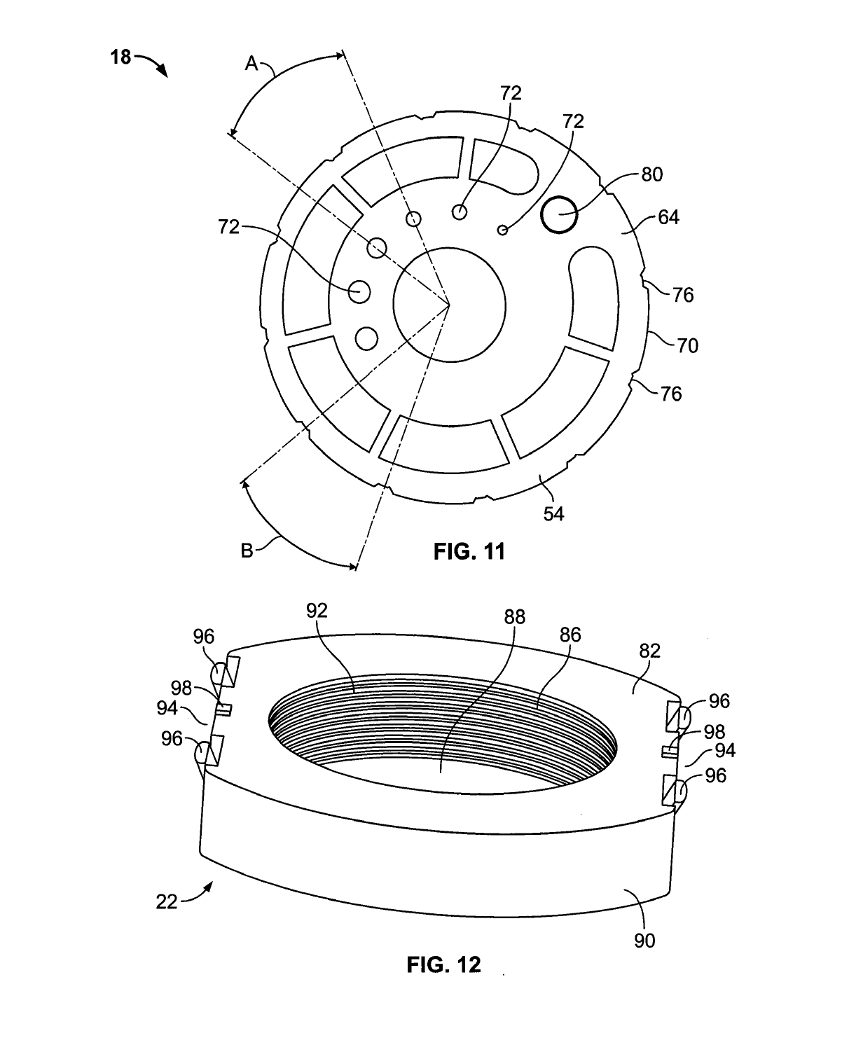

Continuing to refer to FIGS. 2-4B, 6, 10 and 11, in an embodiment, the disk portion 54 of the base 18 includes a first surface 64, a second surface 66 opposite the first surface 64, and an outer radial surface 70 extending therebetween. The second surface 66 includes one or more indentations 68 extending from the outer radial surface 70 generally perpendicularly towards the shank portion 52. Each of a second plurality of apertures 72 extends from the first surface 64 to the second surface 66. Each of the second plurality of apertures 72 is spaced an equal radial distance A from the center points of each other (see FIG. 11). In an embodiment, the second plurality of apertures 72 is arranged in a semi-circular or arcuate orientation (see FIGS. 2-4B, 10 and 11). In other embodiments, the second plurality of apertures 72 is arranged in a circular orientation or other suitable orientation. In the embodiment shown, the second plurality of apertures 72 includes six (6) of the apertures 72. In other embodiments, any number of apertures 72 may be used. In an embodiment, the diameter of each aperture 72 decreases from one end of the arcuate arrangement of the apertures 72 to the other end of the arcuate arrangement of the apertures 72. More particularly, the second plurality of apertures 72 is arrayed in a semi-circular manner wherein each of the second plurality of apertures 72 increases in diameter in the clockwise direction when the base 22 is viewed from the bottom, i.e., viewed from the mask 10 (see FIGS. 10 and 11). As will be described in detail below, the plurality of apertures 72 permits the passage of inhaled air therethrough at a variable rate and resistance. As will be also discussed below, the second plurality of apertures 72 of the base 18 is configured to overlay the first plurality of apertures 28 of the cap 20 such that each of the second plurality of apertures 72 of the base 18 aligns with a corresponding one of the first plurality of apertures 28 of the cap 20 when the insert 12 is in the first fully “open” position (see FIG. 4A). When described together hereinafter, the first plurality of apertures 28 and the second plurality of apertures 72 will be referred to as the “plurality of apertures 74.”

Referring now to FIGS. 2, 3 and 6, the outer radial surface 70 includes a plurality of grooves or notches 76 formed therein and extending generally perpendicularly between the first surface 64 and the second surface 66 and spaced an equal radial distance B from each other. As will be described in detail below, radial distance A corresponds to radial distance B (see FIG. 11) such that, starting from the notch 76 that corresponds to the “open” position (i.e., when the plurality of apertures 74 are unobstructed, see FIG. 4A), each consecutive notch 76 of the plurality of notches 76 corresponds to an additional one of the plurality of apertures 74 being incrementally “closed” (i.e., shut off) by the rotation of the cap 20 (see FIG. 4B). This allows for the sequential stepwise opening or closing off of each of the plurality of apertures 74 when a user rotates the cap 20 in a clockwise or counterclockwise direction, respectively, when viewed from the breathing mask 10 out towards the valve 16 (see FIGS. 4A and 4B).

Continuing to refer to FIGS. 2, 3 and 6, in an embodiment, the outer radial surface 70 further includes a groove 78 formed circumferentially and intermediate the first and second surfaces 64, 66. The groove 78 is adapted to mate with the lip 48 of the cap 20 so as to facilitate connection between the cap 20 and the base 18. The first surface 64 further includes a stop member 80 extending therefrom at a location proximate to the radial surface 70. The stop member 80 is sized and shaped to engage and fit within the channel 46 of the cap 20.

Referring now to FIGS. 2, 3 and 12, in an embodiment, the connecting ring 22 has a generally circular ring-like structure and includes a first surface 82 and a second surface 84 opposite the first surface 82. Extending between the first surface 82 and the second surface 84 is an inner radial surface 86 which defines an interior aperture 88 and an outer radial surface 90 opposite the inner radial surface 86. The inner radial surface 86 is provided with a plurality of internal threads 92 which threadedly engage the plurality of external threads 62 of the base 18. As will be discussed below, the connecting ring 22 is sized and shaped so as to fit within and be secured removably to the port 14 of the face mask 11.

Continuing to refer to FIGS. 2, 3 and 12, cutaways 94 are located at opposing ends of the outer radial surface 90 of the connecting ring 22 and include one or more clips 96 formed integrally therewith which mate with the port 14 of the face mask 11 so as to secure the connecting ring 22 thereto. One or more projections 98 are located on the first surface 82 of the connecting ring 22 which are adapted to communicate with the one or more indentations 68 located on the second surface 66 of the disk portion 54 of the base 18. The second surface 84 of the connecting ring 22 includes an upraised lip 100 located proximate the inner radial surface 86 and is adapted to communicate with the face mask 11 so as to be positioned securely therein.

Referring now to FIGS. 1 and 2, the port 14 of the face mask 11 includes at least one lip 104 to which the clips 96 of the connecting ring 22 engage. In other embodiments, the port 14 may be provided with a plurality of threads (not shown) so as to threadedly engage with a connecting ring 22 similarly including a plurality of external threads (not shown). Once again, the breathing mask 11 may be any breathing mask, gas mask, or respirator known in the art which can accommodate or be configured to accommodate the insert 12.

In an embodiment, each of the components of the valve 16, namely, the base 18, the cap 20, and the ring 22, are each formed of a rigid, lightweight material such as a polymer plastic or other suitable material known in the art. These components may be formed by injection molding or other methods known in the art.

The method of assembly and use of the mask 10 will now be described with reference to an exemplary embodiment thereof. With reference to FIGS. 1 and 4A-5, the cap 20 and base 18 are attached rotatably to one another, and can be done so by press-fitting or interference-fitting so as to form the valve 16 in which the stop member 80 is positioned within the channel 46 at a location corresponding to the “open” position (see FIG. 4A). The valve 16 is then secured to the port 14 of the face mask 11 via the connecting ring 22. A user may then operate the valve 16 by gripping the plurality of arms 34, tabs 36, and grooves 38 of the cap 20 and conveying a rotational force thereto, thereby, causing the cap 20 to rotate in a clockwise or counterclockwise direction corresponding to the incremental “opening” or “closure” of the plurality of apertures 74.

In operation, the user rotates the cap 20 from the “open” position (i.e., in which each of the plurality of apertures 74 is unobstructed, see FIG. 4A) a sufficient rotational distance in a counterclockwise direction to move the at least one projection 50 from one of the plurality of notches 76 to the next one of the plurality of notches 76. This movement causes one of the plurality of apertures 74 to be obstructed by the cap 20, thereby reducing the maximum amount of airflow allowed through the insert 12 and increasing the air resistance through the inner cavity of the cap 20 and into the face mask 11. The user may continue to rotate the cap 20 so as to incrementally “close” (i.e., obstruct) more apertures 74 until the insert 12 is set in its second “closed” position (see FIG. 4B), which is characterized by only one of the plurality of apertures 74 being in an unobstructed state. In the embodiment shown, this corresponds to a configuration where five (5) apertures 74 are closed and where the remaining open aperture 74 is the smallest in size of the plurality of apertures 74. This corresponds to the minimum amount of airflow and the maximum amount of air resistance, and thereby, the maximum training setting. However, the user is free to manipulate the cap 20 to choose any one of several intermediate points between the “open” state (see FIG. 4A) and the “closed” state (see FIG. 4B) to control the amount of airflow and select the optimal air resistance for the user.

The present invention provides a number of benefits and advantages. For instance, the present invention is constructed of a rigid, lightweight material so as to be resistant to damage while also not significantly burdening a user, and thereby negatively affecting the effectiveness of the training. Additionally, the plurality of apertures 74 allows for the incremental increase or decrease in air resistance so as to optimize training performance. Further, the present invention is adaptable to breathing masks known in the art and does not require purchase of a new or specially designed breathing mask. As mentioned above, the face mask 11 can be a firefighter mask, but it can be other types of masks, such as coal miner masks.

It will be understood that the embodiments described herein are merely exemplary and that a person skilled in the art may make many variations and modifications without departing from the spirit and scope of the invention. All such variations and modifications are intended to be included within the scope of the invention, as embodied in the appended claims.

What is claimed is:

1. A breathing resistance insert for a breathing mask, comprising:
an air resistance valve including,
a cap having a first surface and a second surface opposite said first surface, and a first plurality of apertures each of which extends from said first surface to said second surface, said first plurality of apertures being spaced apart from one another and arranged in an arcuate arrangement, and
a base attached rotatably to said cap, said base having a shank portion and a head located at one end of said shank portion, said head having a first surface and a second surface opposite said first surface of said head, and a second plurality of apertures each of which extends from said first surface of said head to said second surface of said head, said second plurality of apertures being spaced apart from one another and arranged in an arcuate arrangement,
wherein said cap is rotatable relative to said base between a first position, in which each of said first plurality of apertures of said cap is aligned with a corresponding one of said second plurality of apertures of said base, and a second position, in which one of said first plurality of apertures of said cap is aligned with one of said second plurality of apertures of said base, and the remainder of said first plurality of apertures of said cap is not aligned with any of the remainder of said second plurality of apertures of said base; and
a connecting ring attached to said shank portion of said base, said ring adapted to be secured to a breathing port of the breathing mask.

2. The breathing resistance insert of claim 1, wherein said cap is rotatable relative to said cap to at least one intermediate position located between the first position and the second position, wherein when said cap is in said at least one intermediate position, at least two of said first plurality of apertures of said cap is aligned with a corresponding one of said second plurality of apertures of said base, and the remainder of said first plurality of apertures of said cap is not aligned with any of the remainder of said second plurality of apertures of said base.

3. The breathing resistance insert of claim 2, wherein said at least one intermediate position includes a plurality of intermediate positions.

4. The breathing resistance insert of claim 3, wherein the diameters of each of said first plurality of apertures decreases sequentially from one end of said arcuate arrangement to an opposite end of said arcuate arrangement, and wherein the diameters of each of said second plurality of apertures decreases sequentially from one end of said arcuate arrangement of said second plurality of apertures to an opposite end of said arcuate arrangement of said second plurality of apertures.

5. The breathing resistance insert of claim 4, wherein said cap includes an inner cavity and an inner radial surface having at least one projection extending therefrom and into said inner cavity, and said base includes an outer radial surface and a plurality of notches formed within said outer radial surface and spaced apart from one another, said at least one projection being sized and shaped to engage each of said plurality of notches at one time and enabling said cap to be rotated relative to said base incrementally from the first position to the second position.

6. The breathing resistance insert of claim 4, wherein said shank portion of said base includes external threads and said connecting ring includes an inner surface having internal threads that engage threadedly said external threads of said shank portion of said base.

7. The breathing resistance insert of claim 6, wherein said connecting ring includes an outer radial surface that is sized and shaped to be inserted within the breathing port of the breathing mask.

8. The breathing resistance insert of claim 7, wherein said connecting ring includes at least one clip adapted to mate with the breathing port of the breathing mask.

9. The breathing resistance insert of claim 5, wherein said cap includes gripping means for facilitating the rotation of said cap relative to said base.

10. The breathing resistance insert of claim 5, wherein the breathing mask is a firefighter mask.

11. In combination, a breathing mask having a breathing port; and
a breathing resistance insert having an air resistance valve including,
a cap having a first surface and a second surface opposite said first surface, and a first plurality of apertures each of which extends from said first surface to said second surface, said first plurality of apertures being spaced apart from one another and arranged in an arcuate arrangement, and
a base attached rotatably to said cap, said base having a shank portion and a head located at one end of said shank portion, said head having a first surface and a second surface opposite said first surface of said head, and a second plurality of apertures each of which extends from said first surface of said head to said second surface of said head, said second plurality of apertures being spaced apart from one another and arranged in an arcuate arrangement,
wherein said cap is rotatable relative to said base between a first position, in which each of said first plurality of apertures of said cap is aligned with a corresponding one of said second plurality of apertures of said base, and a second position, in which one of said first plurality of apertures of said cap is aligned with one of said second plurality of apertures of said base, and the remainder of said first plurality of apertures of said cap is not aligned with any of the remainder of said second plurality of apertures of said base; and
a connecting ring attached to said shank portion of said base, said ring adapted to be secured to said breathing port of said breathing mask.

12. The combination of claim 11, wherein said cap is rotatable relative to said cap to at least one intermediate position located between the first position and the second position, wherein when said cap is in said at least one intermediate position, at least two of said first plurality of apertures of said cap is aligned with a corresponding one of said second plurality of apertures of said base, and the remainder of said first plurality of apertures of said cap is not aligned with any of the remainder of said second plurality of apertures of said base.

13. The combination of claim 12, wherein said at least one intermediate position includes a plurality of intermediate positions.

14. The combination of claim 13, wherein the diameters of each of said first plurality of apertures decreases sequentially from one end of said arcuate arrangement to an opposite end of said arcuate arrangement, and wherein the diameters of each of said second plurality of apertures decreases sequentially from one end of said arcuate arrangement of said second plurality of apertures to an opposite end of said arcuate arrangement of said second plurality of apertures.

15. The combination of claim 14, wherein said cap includes an inner cavity and an inner radial surface having at least one projection extending therefrom and into said inner cavity, and said base includes an outer radial surface and a plurality of notches formed within said outer radial surface and spaced apart from one another, said at least one projection being sized and shaped to engage each of said plurality of notches at one time and enabling said cap to be rotated relative to said base incrementally from the first position to the second position.

16. The combination of claim 15, wherein said shank portion of said base includes external threads and said connecting ring includes an inner surface having internal threads that engage threadedly said external threads of said shank portion of said base.

17. The combination of claim 16, wherein said connecting ring includes an outer radial surface that is sized and shaped to be inserted within the breathing port of the breathing mask.

18. The combination of claim 17, wherein said connecting ring includes at least one clip adapted to mate with the breathing port of the breathing mask.

19. The combination of claim 15, wherein said cap includes gripping means for facilitating the rotation of said cap relative to said base.

20. The combination of claim 15, wherein the breathing mask is a firefighter mask.
